(19) United States
(12) Patent Application Publication
(10) Pub. No.: US 2020/0027343 A1
(43) Pub. Date: Jan. 23, 2020

(54) Snow and Ice Mitigating Traffic Light Lenses and Lens Covers

(71) Applicant: The Regents of the University of Colorado, a body corporate, Denver, CO (US)

(72) Inventors: Ronald A. Rorrer, Highlands Ranch, CO (US); Drew W. Hanzon, Denver, CO (US); Alexander M. Mertz, Denver, CO (US); Megan Lopp, Elizabeth, CO (US)

(21) Appl. No.: 16/476,182

(22) PCT Filed: Jan. 4, 2018
(86) PCT No.: PCT/US18/12416

§ 371 Date: Jul. 5, 2019

Related U.S. Application Data
(60) Provisional application No. 62/443,511, filed on Jan. 6, 2017.

(51) Int. Cl. G08G 1/095; F21V 15/01

(52) U.S. Cl. CPC G08G 1/095; F21V 15/01

(57) ABSTRACT

Lenses and lens covers are shaped to smoothly funnel air along traffic light lenses in a substantially laminar flow. They include one or more concave surfaces and minimize stagnation and recirculation zones in the snow or ice laden air either out of the visor or away from the lens. Some versions include two concave surfaces which meet at a center split line and sweep backwards. The concave surfaces turn the incoming air flow slowly compared to the convex lens surfaces currently in use.

### BACKGROUND OF THE INVENTION

### Field of the Invention

The present invention relates to snow and ice mitigating traffic light lenses and lens covers. In particular, the present invention relates to lenses/covers configured to cause smooth, substantially laminar airflow with no abrupt changes in direction that cause entrained ice/snow particles to eject from the flow.

### Discussion of Related Art

Snow and ice buildup on the lenses of traffic light lenses poses a safety hazard for drivers during winter storm conditions by blocking, most importantly, the red light at the top of the light tree. In the past there have been various methods used in an effort to mitigate or eliminate snow and ice buildup.

The replacement of incandescent traffic lights with LEDs reduced the amount of heat present at the lens face and in the visor volume. This had the unintended consequence of increasing the amount of snow and ice accumulation on the lens and in the visor volume for LED relative to incandescent lights. This is clearly a problem in areas with winter storms and winds above 4.5 m/s (10 mph). Incandescent lights generate sufficient heat that melting of the ice and snow accumulation during winter storms tended to occur. Since the LED lights are significantly more efficient, many departments of transportation are reluctant to replace them with incandescent lights despite increased safety concerns.

Traffic lights are either oriented vertically or horizontally. Field observations of traffic light lenses during snow or ice storms have the following observations. The horizontally oriented lights, which in general have partial visors, have snow and ice buildup on the lens. Vertically oriented lights predominately have snow build-up in the visor tunnel.

FIGS. 1A and 1B (Prior Art) are schematic drawings showing how snow 105 tends to accumulate on a traffic light tree 100 having conventional lenses 104, regardless of whether or not it sticks to the lens surface. FIG. 1A shows a vertical traffic light tree 100 from the front. Conventional visors 102 typically include cutout slots at the bottom to allow matter to drop through. However, snow 105 piles up on the tops of visors 102, and given enough snow, lenses 104 start to become blocked. This is especially the case with the top, red, light. FIG. 1B shows traffic light tree 100 from the side. Snow inside visors 102 would not be visible from the side but is shown in a lighter color for clarity. FIG. 3A is a side cross-section schematic view illustrating air current paths with traffic light tree 100. FIG. 3C is an isometric view of a portion of the experimental airflow for traffic light tree 100.

While the buildup ice and snow on the lenses and visors of traffic signals represents a significant public safety concern, there are number of factors limiting the implementation of mitigation techniques. The most significant is that the infrequent and limited duration of the weather conditions that result in equipment failure. Depending on location the frequency of such conditions can range from an almost daily concern during winter months to only occurring once every several years. An optimal design would limit expenditures through minimal capital outlay as well as require low operational and maintenance costs. All of this converges to the adoption of a passive design (as opposed to active such as continual cleaning, application of deicing chemicals or the introduction of a heating element) that can be employed without requiring maintenance.

The two design features of existing traffic signals that can be readily adapted to meet the functional requirements as well as the previously described practical limitations are the lens or a lens cover. These components can be easily replaced or retrofitted as they are modular in the traffic light as well have the greatest impact on the buildup of ice and snow during blizzard conditions.

There are systems known in the art that are intended to mitigate the problem of snow and ice blocking traffic lights. One example is the Fortran Snow Sentry™ lens cover, shown in FIGS. 2A-2C (Prior Art). The concept of the Snow Sentry™ is essentially to tilt the lens forward at the top. FIG. 2A shows a conventional traffic light lens 102. FIG. 2B shows how the lens is tilted forward, and FIG. 2C shows the Snow Sentry™ lens. Interestingly, the manufacturer makes no claim about aerodynamics, simply stating that this lens cover reduces snow and ice build-up. FIG. 3B is a side cross-section schematic view illustrating air current paths with traffic light tree for the Snow Sentry™, showing recirculation of the flow at the top of the visor 200.

In contrast to the Snow Sentry™ lens 202, there are a variety of visor scoops that have been tested by departments of transportation. These visor scoops are exemplified by the McCain Snow Scoop 302, shown conceptually in FIG. 4 (Prior Art). In theory, the purpose of scoop portion 306 is to wash the face of the lens 304 (which might be conventional lens 104). Visor scoop 302 can be retrofitted to a traffic light 300. However, the scoop does not operate as intended instead air flows out of the scoop and the scoop becomes clogged with snow. FIG. 5 is a side cross-section schematic view illustrating air current paths with McCain visors 302 on a vertical traffic light tree 300.

The previous attempts to minimize or eliminate snow and ice build-up on traffic lights do not substantially minimize or eliminate the recirculation or stagnation of air flow in the visor volume over the standard lens/visor combination.

A need remains in the art for aerodynamic changes to traffic light lenses and/or lens covers to avoid snow and ice buildup.

### SUMMARY

It is an object of the present invention to provide aerodynamic changes to traffic light lenses and/or lens covers to avoid snow and ice buildup. The shape of these lenses/covers include one or more concave surfaces to smoothly funnel air along the lens in substantially laminar flow.

The commonality between all of the proposed traffic light modifications is the minimization or elimination of stagnation and recirculation zones in the snow or ice laden air either out of the visor or away from the proposed lens cap. This is accomplished by replacing the convex surface of current traffic light lenses with a concave surface in the case of a replacement lens or lens visor assembly or in the case of a lens cap, two concave surfaces which meet at a center split line. The concave surfaces turn the incoming air flow slowly compared to the convex lens surface currently in use.

An embodiment of the present invention comprises a concave lens or lens cover in the general shape of the inside of a sea shell to direct the flow of incoming snow or ice laden air out the slot at the bottom of a conventional visor with the goal of eliminating stagnation zones and having the air flow smoothly out of the visor. Instead of simply rotating the standard lens forward, conceptually this design flips the current convex commercial lens and rotates it forward creating a concave surface. This embodiment funnels air to the slot opening at the bottom of the visor while minimizing or eliminating stagnation zones and recirculation at the top of the visor.

A second embodiment of a lens or lens cover includes a vertical center line on the lens or cover with two concave surfaces of the lens/cover sweeping back from the center line. This embodiment could also tilt forward at the top, and could be configured to cover all of the lenses and visors of the traffic light tree.

A traffic light lens according to the present invention includes a concave surface shaped to guide wind incident on the surface smoothly in a substantially laminar flow. The concave surface may also be tilted forward at the top. In some embodiments the concave surface is generally parabolic in shape.

An embodiment especially useful for horizontally oriented traffic light trees includes a midline and a second concave surface, wherein the two concave surfaces sweep back from the midline. Preferably the midline is vertical. Wind incident on the surface from a side exits outward from the surface and wind incident on the surface from the front exits to the sides of the surface.

The surface may be integral with the lens, form a cover placed over the lens, or be attached to a visor affixed adjacent to and partially surrounding the lens.

### BRIEF DESCRIPTION OF THE DRAWINGS

FIG. 1A (Prior Art) is a schematic diagram showing a front view of a conventional vertical traffic light tree with snow and ice build-up. FIG. 1B (Prior Art) is a side view of the traffic light tree of FIG. 1A.

FIGS. 2A-C (Prior Art) are side schematic views illustrating how a Snow Sentry™ lens varies from a conventional lens such as those of FIGS. 1A and 1B. FIG. 2A is a side schematic view of a conventional lens. FIG. 2B shows how the front surface of the conventional lens is essentially tilted forward at the top. FIG. 2C shows the Snow Sentry™ lens.

FIG. 3A (Prior Art) is a side cross-section schematic view illustrating air current paths with conventional traffic light lenses.

FIG. 3B (Prior Art) is a side cross-section schematic view illustrating air current paths with a Snow Sentry™ traffic light lens.

FIG. 3C (Prior Art) is an isometric view of a portion of the experimental airflow for the lenses of FIGS. 1A and 1B

FIG. 4 (Prior Art) is an isometric drawing of a McCain Snow Scoop Visor.

FIG. 5 (Prior Art) is a side cross-section schematic view illustrating air current paths with McCain visors on a vertical traffic light tree.

FIGS. 6A-6C are side schematic views illustrating how a first embodiment of a lens according to the present invention varies from a conventional lens such as those of FIGS. 1A and 1B. FIG. 6A is a side schematic view of a conventional lens. FIG. 6B shows how the front surface of the conventional lens is reversed and tilted forward at the top. FIG. 6C shows the first embodiment of the lens.

FIGS. 7A and 7B are front and side views of the lens of FIGS. 6A-C.

FIG. 8 is a side cross-section schematic view illustrating air current paths with the lenses of FIGS. 6A-7B on a vertical traffic light tree.

FIG. 9 is an isometric view of a portion of the experimental airflow for the lenses of FIGS. 6A-7B

FIG. 10A is an isometric drawing of a traffic light lens cover according to the present invention.

FIG. 10B shows the cover of FIG. 10A with a front plane indicated.

FIG. 11A is a schematic drawing illustrating airflow given wind from the front of the lens of FIG. 10A.

FIG. 11B is a schematic drawing illustrating airflow given wind from the sides of the lens of FIG. 10A.

FIGS. 12A-12D illustrate a third embodiment of the present invention, comprising a shroud for covering the lenses and visors of a vertical traffic light tree. FIG. 12A is a side view of the shroud, FIG. 12B is a front view of the shroud, FIG. 12C is a front view of the shroud installed on a traffic light tree, and FIG. 12D is a side view of the shroud installed on a traffic light tree.

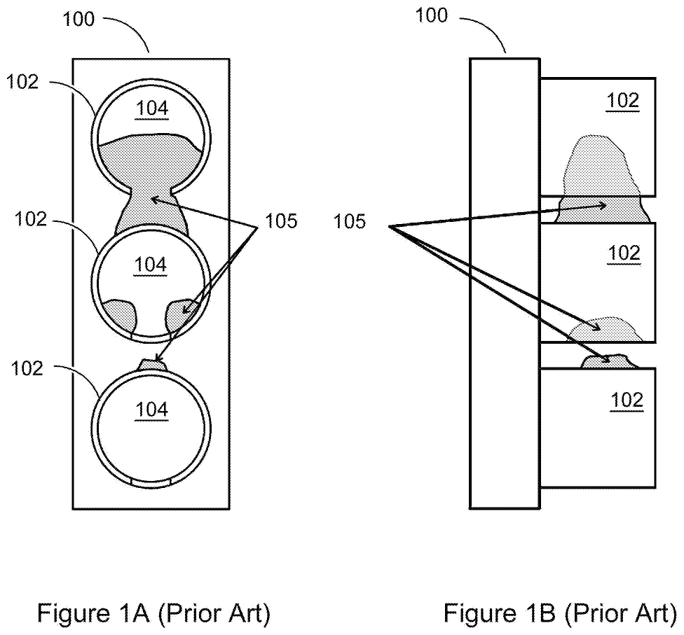

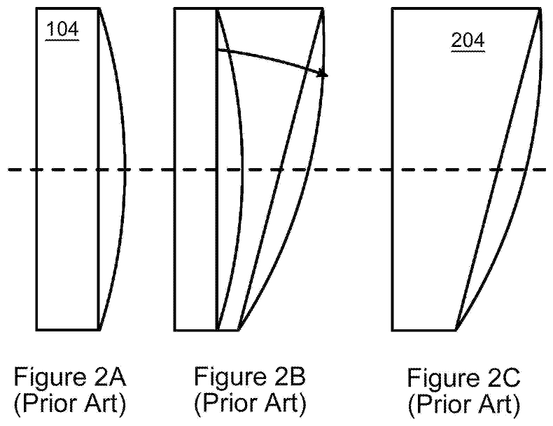

### DETAILED DESCRIPTION OF THE INVENTION

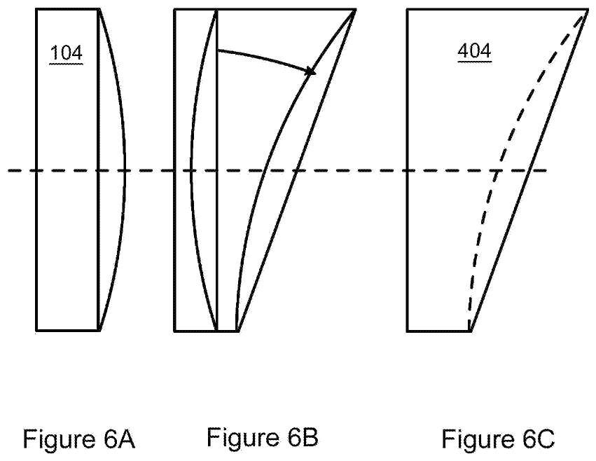

FIGS. 6A-6C are side schematic views illustrating how a first embodiment of a lens 404 according to the present invention varies from a conventional lens 104. FIG. 6A is a side schematic view of conventional lens 104, which comprises a convex surface. FIG. 6B shows how the front surface of conventional lens 104 is reversed (to form a concave surface) and tilted forward at the top. FIG. 6C shows lens 404, which has a concave surface.

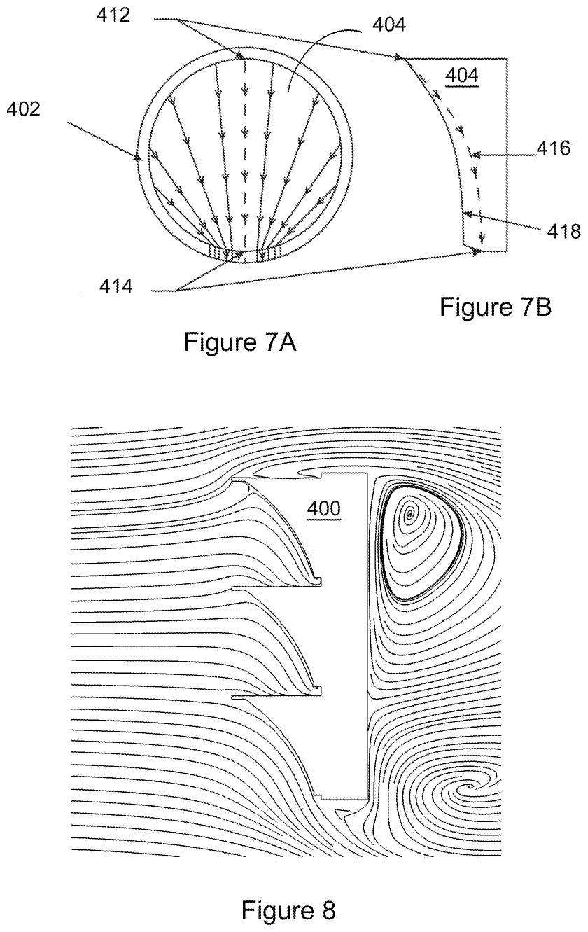

FIGS. 7A and 7B are front and side views of 404. FIG. 7A shows schematically how air flow is directed down and inward to the slot opening at the bottom of visor 402. The lines indicating airflow do not cross, indicating that the flow is smooth and substantially laminar. FIG. 7B is a side view of lens 404. 418 is the edge of lens 404 and 416 is the center line. Note that lens 404 could also comprise a cover for a conventional lens such as 104. This cover could then snap over lens 104 or could be built into visor 402 for convenient retrofitting.

FIG. 8 is a side schematic view illustrating air current paths with lenses 404 installed in a vertical traffic light tree 400. The air flow in front of the lenses is substantially laminar, meaning (1) it flows in parallel layers, without disruption between the layers; (2) there aren't cross-currents perpendicular to the direction of flow, nor eddies or swirls of fluids; and (3) there aren't abrupt changes in direction that may cause entrained ice/snow particles to eject from the flow. This is indicated in FIG. 8 by the lack of broken lines and swirls in the cross-sectional flow lines. The only broken line and beginning of a swirl is seen right above the top lens 404. Thus, the air flow in front of the lenses is substantially laminar according to the definition herein.

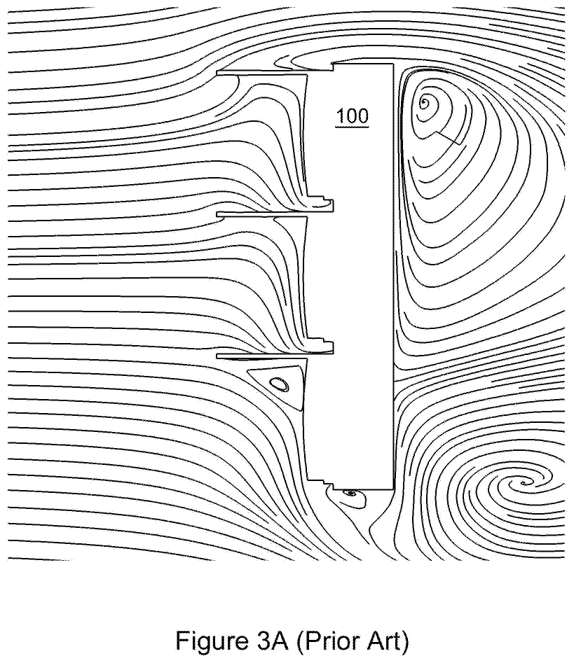

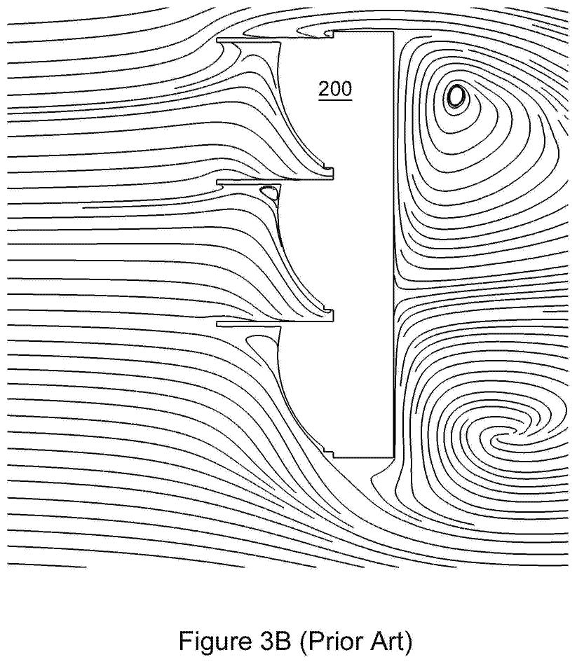

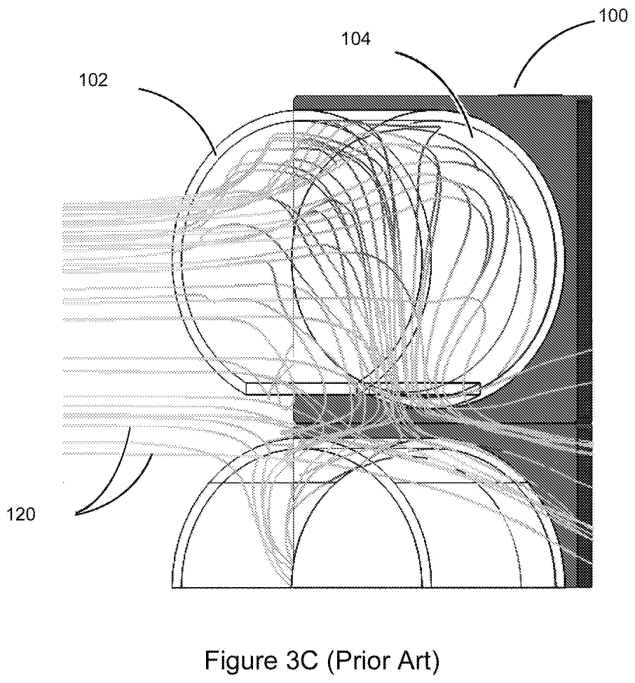

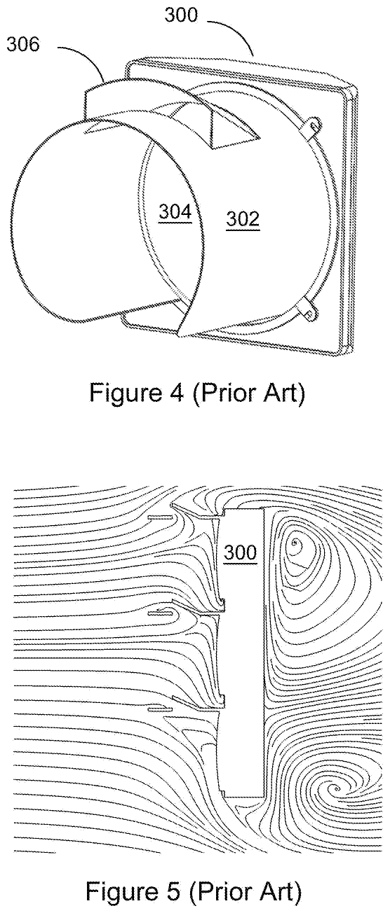

Returning to prior art FIGS. 3A, 3B, and 5, each shows significant turbulence, indicated by broken lines and swirls in front of the lenses 104, 204, 304. FIG. 3A shows substantial recirculation in bottom lens 104 as evidenced in the bottom lens/hood, violating condition (2). It also has abrupt changes in direction in the top and middle lens that would violate condition (3). It also shows neighboring streamlines that are not parallel and some that diverge which violates condition (1).

FIG. 3B shows recirculating streamlines in the middle and bottom lens violating condition (2). It also has a zone of diverging/nonparallel streamlines in the top lens/hood that is due to the convex cure of the lens. This area extends down over the lens rather than stopping at the top of lens as in FIG. 8. FIG. 5 also shows several intersecting and diverging streamlines as well as abrupt changes in direction

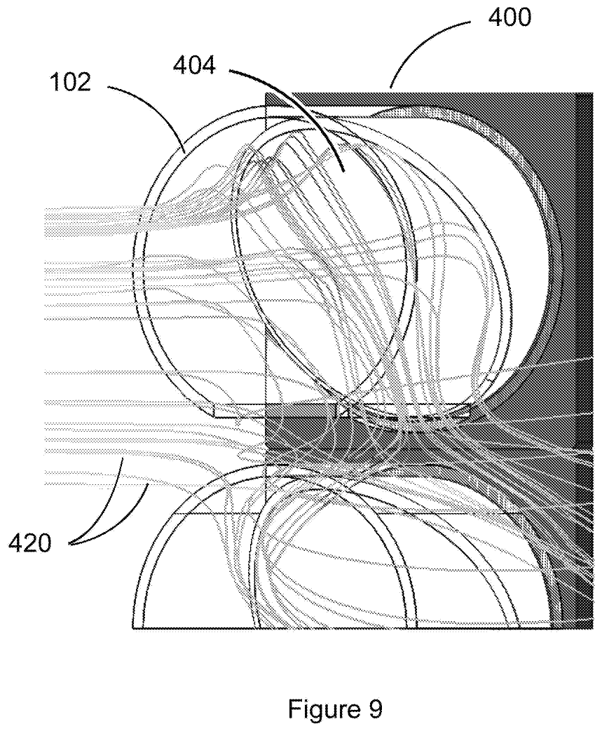

FIG. 9 is an isometric schematic view of a portion of the experimental airflow for lenses 404. FIG. 8 is a cross-section of this flow. The airflow in this schematic is representative of the results of both experimental wind tunnel tests and computational fluid dynamics modeling. The flow is entering the front of the visor from the left and then flowing out the bottom slot of the visor to the right. For comparison to FIG. 3C, the airflow in FIG. 9 more directly flows out of the visor bottom slot. The airflow in FIG. 3C moves up toward the top of the visor earlier in the visor tunnel, causing more stagnation and recirculation which can also be seen in FIG. 3B which is a cross-sectional view of the flow of FIG. 3C.

Tests were conducted in a 20.32×20.32 cm wind tunnel on a ⅓ scale model of a stop light. Due to the size constraint, only approximately half of a traffic light model was used. The purpose of this testing was to determine the air flow around the top lens with the effect of both the top and middle visor. The absolute air speed in the wind tunnel was 20 m/s, which is 6.7 m/s for a full-scale traffic light. This velocity is considered to be the speed at which snow and ice will buildup on a lens during a snow or ice storm.

Visualization was accomplished by directing two streams of fog (propylene glycol and water) towards the two lenses as shown in later figures in the results section. The purpose of the testing was to generate a qualitative understanding of the air flow patterns due to the various lens and visor combinations tested. The fog was generated by a commercial fog machine manufactured by Chauvet. The fog was directed by splitting the flow to strike both lenses approximately ⅓ from the top of the lens. The fog stream was somewhat turbulent for both lens 104 and 404, but considerably choppier for lens 104. Computational fluid dynamics was performed wind tunnel results to generate the qualitative picture obtained from the wind tunnel to a quantitative basis as shown in FIGS. 3C and 9.

FIG. 3C (Prior Art) shows airflow for a standard lens 104 and visor 102 combination. It is useful to note the aggregation of airflow in the upper region of the visor nearest the lens as well as the ejection of flow through the lower opening of the visor. The wind tunnel results show air being pushed over the top of the visor, but this is not shown in FIG. 3C for clarity. FIG. 9 shows the result for lens 404, and evidences far less stagnation volume as evidenced by the both the continuity of the airflow streamlines as well as the more direct path that the airflow takes from entry to exit of the visor. In FIG. 3C, some of the air flow actually is shown to stagnate on the lens as indicated by the streamlines which end and do not flow out of the visor.

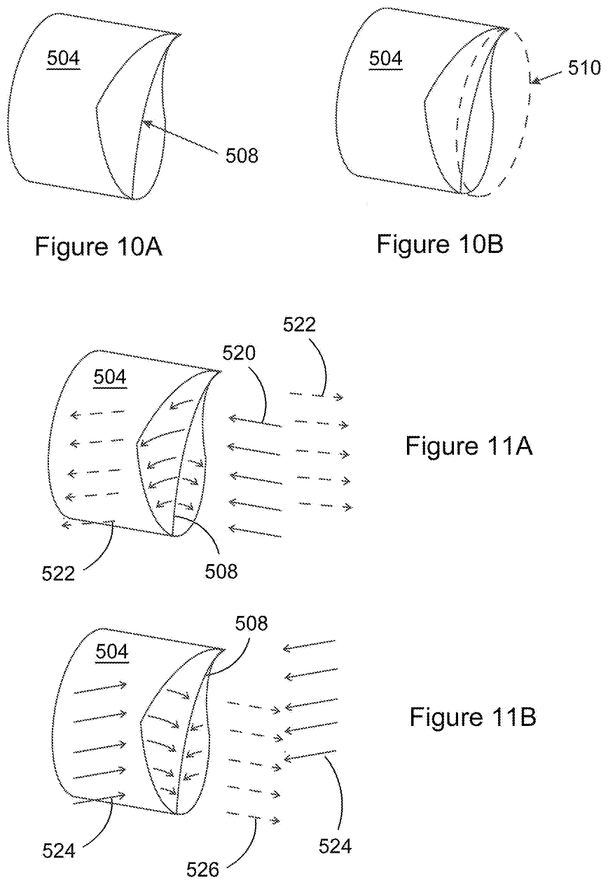

FIG. 10A is an isometric drawing of a traffic light lens cover 504. FIG. 10B shows the cover of FIG. 10A with a front plane indicated. Lens cover 504 is particularly convenient for use in horizontal traffic light trees. The surface of lens cover 504 sweeps back from a vertical center line 508, and each half is concave as well. It would also be possible for this surface to be integral with the lens rather than forming a cap to cover a lens or being attached to a visor. As an alternative, this shape could be formed directly on the lens, but generally a retrofit cover will be more economical.

FIG. 11A is a schematic drawing illustrating airflow given wind 520 from the front of lens cover 504. Air is swept sideways as shown, resulting in sideways airflow 522. FIG. 11B is a schematic drawing illustrating airflow given wind from the sides of the lens cover 504. Here, the wind is coming in from one side or the other (both are shown) and air is swept into center line 508 resulting in both outward and downward flow 526.

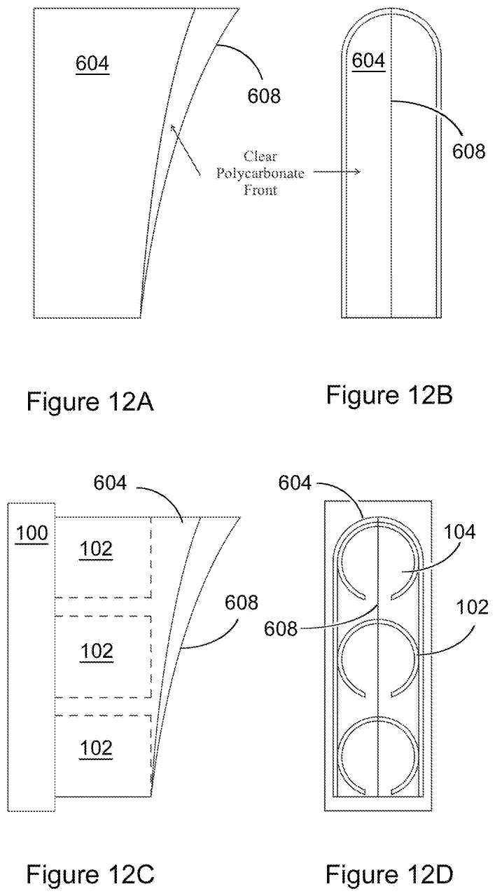

FIGS. 12A-12D illustrate a third embodiment of the present invention, comprising a cover or shroud 604 for covering the lenses and visors (e.g. lenses 104 and visors 102) of a vertical traffic light tree (e.g. 100). FIG. 12A is a side view of shroud 604, FIG. 12B is a front view of shroud 604, FIG. 12C is a front view of shroud 604 installed on a traffic light tree 100 (shown in broken lines), and FIG. 12D is a side view of shroud 604 installed on a traffic light tree 100 with lenses and visors visible through shroud 604. The design of shroud 604 incorporates features of lens 404 and lens cover 504. It includes two concave surfaces sweeping back from a midline 608, and it also tilts forward at the top. Shroud 604 might comprise clear polycarbonate through which lenses 104 are visible, and is configured to fit over visors 102.

While the exemplary preferred embodiments of the present invention are described herein with particularity, those skilled in the art will appreciate various changes, additions, and applications other than those specifically mentioned, which are within the spirit of this invention. The concept of the proposed lenses/covers can be applied to other applications of lights, cameras, lasers or any other light transmitting or measuring (such as sensor) devices, which operate in environments where build-up of air laden particles can accumulate on the lens and negatively affect their function. Examples include traffic cameras and sensors, vehicle headlights and automatic security gate sensors.

1. A traffic light lens including a concave surface shaped to guide wind incident on the surface smoothly in a substantially laminar flow.

2. The lens of claim 1, wherein the concave surface is tilted forward at the top.

3. The lens of claim 2 wherein the concave surface is generally parabolic in shape.

4. The lens of claim 1 further comprising a midline and a second concave surface, wherein the two concave surfaces sweep back from the midline.

5. The lens of claim 4 wherein the midline is vertical and wherein wind incident on the surface from the side exits outward from the surface and wind incident on the surface from the front exits to the sides of the surface, with an additional downward component of flow.

6. The lens of claim 1 wherein the surface is integral with the lens.

7. The lens of claim 1 wherein the surface is formed on a cover fitted over the lens.

8. The lens of claim 1 wherein the surface is attached to a visor configured to be affixed adjacent to and partially surrounding the lens.

9. The lens of claim 8, further comprising a midline and a second concave surface, wherein the two concave surfaces sweep back from the midline, and wherein the surfaces are tilted forward at the top.

10. A cover for a traffic light lens including a concave surface shaped to guide wind incident on the surface smoothly in a substantially laminar flow.

11. The cover of claim 10, wherein the concave surface is tilted forward at the top.

12. The cover of claim 11 wherein the concave surface is generally parabolic in shape.

13. The cover of claim 10 further comprising a midline and a second concave surface, wherein the two concave surfaces sweep back from the midline.

14. The cover of claim 13 wherein the midline is vertical and wherein wind incident on the surface from the side exits outward from the surface and wind incident on the surface from the front exits to the sides of the surface, and both downward.

15. The cover of claim 10 wherein the surface is formed as a cap fitted over the lens.

16. The cover of claim 10 wherein the surface is attached to a visor configured to be affixed adjacent to and partially surrounding the lens.

17. The cover of claim 10, further comprising a midline and a second concave surface, wherein the two concave surfaces sweep back from the midline, and wherein the surfaces are tilted forward at the top.

18. The cover of claim 17 configured to cover multiple lenses and visors.
